(19) United States
(12) Patent Application Publication
(10) Pub. No.: US 2026/0186455 A1
(43) Pub. Date: Jul. 2, 2026

(54) SYSTEM AND METHOD FOR GENERATING REAL-TIME DECARBONIZATION ROADMAPS FOR INDUSTRIAL FACILITIES

(71) Applicant: Saudi Arabian Oil Company, Dhahran (SA)

(72) Inventors: Rakan S. Bilaus, Dammam (SA); Mohammed W. Al Laban, Dammam (SA); Ali AlMutawa, Mubarraz (SA); Christopher E. Stapp, Dhahran (SA)

(73) Assignee: Saudi Arabian Oil Company, Dhahran (SA)

(21) Appl. No.: 19/005,103

(22) Filed: Dec. 30, 2024

(51) Int. Cl. G05B 13/04; G06Q 10/04; G06Q 10/0637

(52) U.S. Cl. CPC G05B 13/042; G06Q 10/04; G06Q 10/0637

(57) ABSTRACT

Systems and methods for generating and implementing real-time decarbonization roadmaps for at least one industrial facility are disclosed. In one embodiment, a method comprises obtaining GHG emissions data from at least one sensor associated with the facility's equipment, storing and categorizing the emissions data according to direct and indirect (Scope 1 and Scope 2) emissions, and forecasting long-term emissions under a business-as-usual scenario. The method further involves receiving and evaluating decarbonization initiatives—such as energy efficiency measures, carbon capture and storage (CCS) projects, or emissions offsetting strategies—based on their applicability and cost-effectiveness. By generating marginal abatement cost curves (MACCs) that consider capital and operational expenses, implementation feasibility, and project timelines, the method identifies prioritized emissions reduction measures. The output includes implementation directives provided to a controlled facility emissions system, which can adjust equipment parameters, integrate renewable energy solutions, or otherwise modify operating conditions to achieve targeted GHG reductions.

### FIELD

The present disclosure relates to systems and methods for generating and implementing decarbonization initiatives.

### TECHNICAL BACKGROUND

As environmental regulations tighten and corporate sustainability goals become more ambitious, facility operators may encounter challenges when accurately quantifying and reducing their carbon footprint. Conventional methods for forecasting emissions frequently depend on static spreadsheets, manual data gathering, and basic assumptions that fail to reflect the complex, dynamic operations of contemporary industrial facilities. These shortcomings in forecasting may hinder the identification of cost-effective, technically feasible decarbonization measures and slow the implementation of emissions reduction initiatives.

### SUMMARY

Emission forecasting and decarbonization roadmap development represent important aspects of modern industrial operations, enabling organizations to effectively predict greenhouse gas (GHG) emissions and plan emission reduction initiatives at both facility and corporate levels. This discipline encompasses the automated gathering, normalization, and utilization of various data sources and analytical models to represent dynamic operational environments, including equipment-level performance metrics, energy consumption patterns, and identified decarbonization strategies. Effective greenhouse gas (GHG) emissions forecasting and decarbonization roadmap management facilitate decision-making, capital allocation, and long-term sustainability planning across a broad range of industrial settings. By leveraging real-time data integration and marginal abatement cost curve (MACC) analyses, organizations can gain insights into current and projected emissions profiles, identify cost-effective reduction measures, and achieve alignment with corporate-level sustainability targets. This leads to more informed strategies, improved operational efficiency, and ultimately supports the transition to lower-carbon industrial operations.

Systems and methods for generating and implementing real-time decarbonization roadmaps for at least one industrial facility are disclosed. In one embodiment, a method comprises obtaining, by at least one sensor coupled to a first network, GHG emissions data associated with equipment of the at least one industrial facility, the GHG emissions data including GHG emission metrics associated with two or more GHG emission types comprising at least one of combustion, venting, flaring, fugitives, and utility consumption; storing, in a GHG emission data memory, the obtained GHG emissions data; executing, by a decarbonization roadmap data processor configured with a memory component storing decarbonization model data processing instructions, steps comprising: forecasting GHG emissions for the at least one industrial facility under a business-as-usual (BAU) scenario using the GHG emissions data, wherein the forecast is for a defined timeframe; categorizing elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources; receiving at least one decarbonization initiative, the at least one decarbonization initiative comprising at least one of an energy efficiency measure, a carbon capture and storage initiative, or a GHG emissions offsetting initiative; identifying one or more of the received decarbonization initiatives applicable to the at least two emissions scopes, wherein the identified one or more decarbonization initiatives are selected based on the GHG emissions sources identified in the emissions data; generating MACCs for the identified one or more decarbonization initiatives, wherein the MACCs include at least one GHG emission reduction metric, at least one associated financial metric including at least one of a capital expenditure, operational expenditure, or lifecycle costs, and at least one implementation metric based on at least one of implementation feasibility or an implementation timeframe; generating one or more implementation directives including at least one of an operational control parameter, a schedule for execution of the identified decarbonization initiative, or a decarbonization roadmap visualization; and communicating the one or more implementation directives to an emission reduction initiative output translator; and implementing, by a controlled facility emissions system in communication with the emission reduction initiative output translator, the one or more implementation directives by performing at least one of: adjusting emissions control devices of the at least one industrial facility, modifying an operating parameter of at least one renewable energy system of the at least one industrial facility, or modifying an operational parameter of equipment of the at least one industrial facility.

In another embodiment, a system includes an industrial facility GHG monitoring framework configured to obtain and store emissions data, a decarbonization roadmap management system having a data processor and memory components for executing decarbonization model instructions, and an emission reduction initiative output translator. Leveraging these components, the system can forecast emissions, categorize them by scope, and identify, analyze, and prioritize relevant decarbonization initiatives. By generating MACCs and translating selected initiatives into actionable directives, the system provides guidance to a controlled facility emissions system that implements real-time adjustments in equipment operations or energy inputs. This comprehensive framework enables data-driven, dynamic, and scalable decarbonization roadmaps aligned with corporate sustainability goals and regulatory requirements. Other embodiments provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

These and additional features provided by the embodiments of the present disclosure will be more fully understood in view of the following detailed description, in conjunction with the drawings.

### BRIEF DESCRIPTION OF THE DRAWINGS

The following detailed description of the present disclosure may be better understood when read in conjunction with the following drawings in which:

FIG. 1 depicts an overview of a system for generating, analyzing, and implementing decarbonization roadmaps for one or more industrial facilities in accordance with aspects of the present disclosure;

FIG. 2 depicts additional details of an emissions forecasting module in accordance with aspects of the present disclosure;

FIG. 3 depicts additional details of a module for identifying potential decarbonization initiatives in accordance with aspects of the present disclosure;

FIG. 4 depicts additional details of a module for aggregating facility-level forecasts and initiative portfolios into corporate-level strategies and investment plans in accordance with aspects of the present disclosure;

FIG. 5 provides an example graphical representation of a long-term GHG emissions profile under a business-as-usual scenario in accordance with aspects of the present disclosure;

FIG. 6 provides an example graphical representation of an asset-level long-term marginal abatement cost curve (MACC) in accordance with aspects of the present disclosure;

FIG. 7 provides an example graphical representation of a long-term emissions roadmap at the asset level in accordance with aspects of the present disclosure;

FIG. 8 provides an example graphical representation of a long-term implementation plan and lifecycle for selected decarbonization initiatives in accordance with aspects of the present disclosure;

FIG. 9 depicts an exemplary process flow for integrating GHG data collection, emissions forecasting, decarbonization initiative analysis, and implementation steps, in accordance with aspects of the present disclosure; and

FIG. 10 depicts a computing device configuration for implementing the decarbonization roadmap system in accordance with aspects of the present disclosure.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Industrial facilities used in oil and gas production, petrochemical refining, manufacturing, and large-scale power generation often operate within complex networks of equipment, utilities, and interdependent processes. Many of these facilities rely on carbon-intensive feedstocks and energy carriers, resulting in the production of GHGs. These GHG emissions can create regulatory, financial, and reputational challenges for operators. In addition to monitoring and measuring their emissions, industrial organizations may develop long-term strategies to minimize their carbon footprint. Identifying pathways to significant, cost-effective emissions reductions may be challenging and time-consuming without reliable, data-driven methodologies.

Traditional approaches to forecasting facility-level GHG emissions and identifying emissions reduction measures have often relied on manual spreadsheets, static assumptions, and limited stakeholder input. These methods may be cumbersome and inaccurate, especially when confronted with changing business conditions, shifting fuel prices, evolving technological capabilities, or new regulatory requirements. As a result, teams assigned to develop decarbonization roadmaps may struggle to incorporate real-time operational data, emerging low-carbon technologies, or updated corporate sustainability goals. This lack of agility and comprehensiveness can lead to suboptimal decision-making, higher capital expenditure (CAPEX) than necessary, and missed opportunities for efficient GHG emissions reduction and offsetting.

In some aspects, facility engineers and corporate planners may work with siloed data sources and outdated forecasting tools that do not reflect the dynamic nature of industrial operations. For example, a single facility might have multiple emissions sources—boilers, furnaces, turbines, flares—each with unique operating schedules and maintenance requirements. Without a flexible and automated system to normalize data, handle operational anomalies, and scale across multiple facilities, generating forward-looking emissions forecasts (e.g., 2035 or 2050) may become prohibitively labor-intensive. Moreover, once forecasts are generated, linking the forecasts to MACCs, prioritizing initiatives, and aligning them with corporate-level targets remains a significant operational hurdle.

By implementing an integrated, automated system that uses real-time operational data, equipment-level metrics, and corporate strategic inputs, aspects of the present disclosure are directed to solve these challenges. In certain aspects, decarbonization modules may collect and categorize emissions data from sensors, control systems, and historical records, forecast future emissions under business-as-usual conditions, and identify a comprehensive set of potential decarbonization initiatives. After analyzing CAPEX, OPEX, project feasibility, and technology readiness, aspects of the present disclosure may rank decarbonization initiatives by their marginal abatement cost. These ranked decarbonization initiatives may be provided as a roadmap that can scale from the facility level to the entire corporate portfolio, ensuring that decision-makers can quickly visualize and implement a coordinated, cost-effective approach to GHG emissions reduction.

For example, if a company operates multiple refineries and gas processing plants, each with distinct equipment configurations and emissions profiles, aspects of the present disclosure may aggregate their data and produce both site-specific and enterprise-wide strategies. By normalizing emissions data to represent steady-state conditions, aspects of the present disclosure avoid skewed forecasts caused by maintenance outages or abnormal operations. In some aspects, known drivers—such as approved efficiency projects, changing feedstock compositions, and anticipated electricity decarbonization—may be integrated into long-range emissions forecasts. These forecasts may inform a decarbonization initiative analysis engine that calculates each project's abatement potential and cost-effectiveness, enabling planners to build marginal abatement cost curves. Decision-makers can more clearly identify which measures yield significant emissions reductions at low cost and which initiatives might be best deferred or replaced with alternative strategies.

Aspects of the present disclosure may be directed to supporting the achievement of corporate-level targets by feeding the outputs of facility-level analyses into a group prioritization engine. The group prioritization engine may consider corporate capital constraints, strategic sustainability objectives, and technology maturity levels to prioritize decarbonization projects across multiple facilities. In so doing, aspects of the present disclosure may enable corporate planners to meet or exceed emissions reduction commitments, respond to external stakeholder pressures, and remain agile in changing market conditions. In some aspects, a company can re-run simulations as new situations arise (e.g., acquisitions, divestments, regulatory updates), ensuring that the roadmap remains current and effective over time.

By employing a unified data environment and advanced forecasting methods, aspects of the present disclosure may reduce the amount of workload previously required to produce decarbonization roadmaps, saving considerable human-hours and freeing technical experts to focus on strategic planning rather than administrative tasks. Automated normalization of emissions data improves accuracy and confidence in baseline GHG emissions metrics. Scenario analysis tools can, in some cases, facilitate quick testing of different assumptions, helping stakeholders evaluate how shifts in production rates, fuel selection, or equipment availability influence long-term goals. Additionally, generating MACCs using real-time data ensures that cost-efficient decisions can be made, facilitating CAPEX reduction while meeting emissions objectives. In some aspects, data from individual facilities can be aggregated into corporate-level strategies to align capital deployment strategies with the company's broader decarbonization goals.

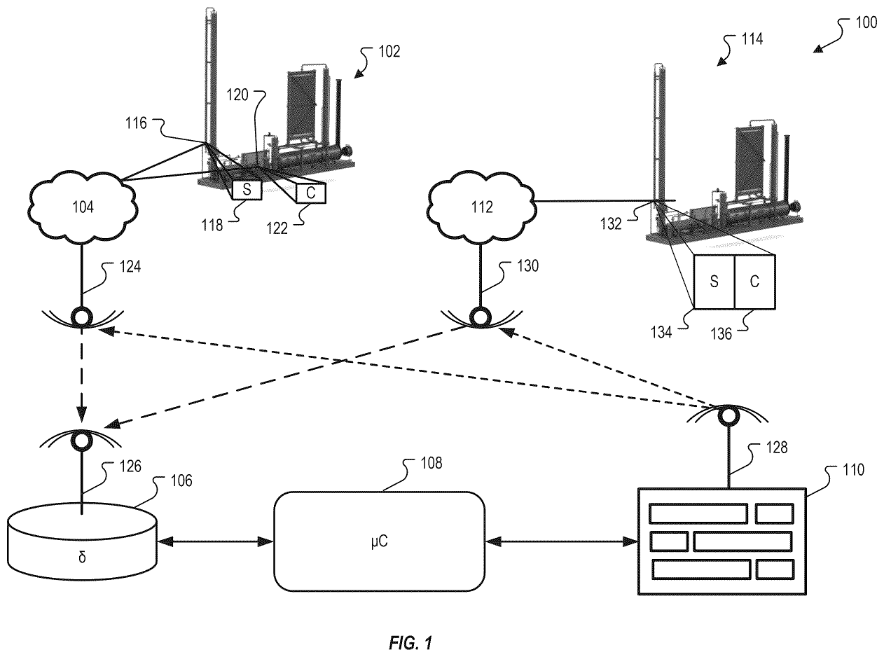

Referring now to FIG. 1, a schematic overview of decarbonization roadmap system 100 and the method for generating, analyzing, and implementing comprehensive decarbonization roadmaps for industrial facilities is depicted in accordance with aspects of the present disclosure. In some aspects, the decarbonization roadmap system 100 facilitates real-time monitoring, forecasting, analysis, and optimization of GHG emissions at the equipment, facility, and corporate levels. This is achieved using a network of sensors, controllers, data processing modules, and communication interfaces. A MACC represents the cost-effectiveness of various decarbonization initiatives by plotting the marginal cost of reducing one ton of GHG emissions against those initiatives'total emissions reduction potential. Decarbonization roadmap system 100 may enable the development of MACCs, project prioritization protocols, decarbonization strategies, and investment plans.

As depicted in FIG. 1, a first facility 102 may be an industrial plant, a petroleum refinery, a gas processing unit, a chemical manufacturing site, a power generation station, or any other industrial operation where the reduction of GHG emissions across Scope 1, Scope 2, and Scope 3 may be relevant. Scope 1 emissions, also referred to as direct emissions, are released directly from on-site equipment owned or controlled by the facility. These include combustion gases from boilers, heaters, and turbines and fugitive emissions from leaks in pipelines or flares. Scope 2 emissions, also referred to as indirect emissions, are those associated with the production and delivery of externally sourced energy consumed by the facility, such as electricity, steam, or hydrogen. Scope 3 emissions, including downstream GHG emissions, result from activities related to the facility's products outside the facility's direct operations. Examples include emissions generated during the transportation, use, or disposal of products, such as the combustion of fuels or the end-use of manufactured chemicals.

The facility 102 may be continuously monitored by a sensor and controller network 116 configured to capture operational parameters (e.g., fuel gas flow rates, energy consumption, steam generation, flaring volumes, venting and fugitive emissions), process conditions, and emissions data at both the equipment and facility levels.

Within facility 102, at least one sensor 118 and one controller 122 are shown as part of the sensor and controller network 116. The at least one sensor 118 may be any suitable device capable of measuring relevant operational and environmental parameters, such as mass flow meters, temperature and pressure transmitters, gas composition analyzers, or infrared cameras for detecting fugitive emissions. Controller 122 may be a programmable logic controller (PLC) or a distributed control system (DCS) component that interfaces with sensors and actuators and communicates the measured data to external systems.

In some aspects, collected data from the sensor and controller network 116 may be communicated to an industrial facility GHG monitoring system 104. The industrial facility GHG monitoring system 104 may be local or remote and receive, process, and store real-time emissions and operational data. As depicted in FIG. 1, data from facility 102 may be transmitted over a communication link to a transmitter 124, which may be a wireless transmitter, a wired modem, a satellite link, or any other suitable communication device. The transmitter 124 may provide secure, continuous, and reliable communication of relevant sensor readings and operational conditions from facility 102 to other parts of decarbonization roadmap system 100. The industrial facility GHG monitoring system 104 and transmitter 124 may be collectively configured to support continuous data streams, on-demand data retrieval, and integration with various databases and forecasting engines.

Similarly, another facility, 114, is depicted on the upper right side of FIG. 1. Facility 114 may be the same type as facility 102 or of a different type and scale. Like facility 102, it may include a sensor and controller network 132 that monitors equipment and operations. Sensor 134 and controller 136 are provided as part of this second facility's 114 control and monitoring apparatus. Collected data from facility 114 may be communicated to a cloud or facility emissions system 112 configured to handle emissions data from facility 114. This data may be transmitted via a transmitter 130 to ensure the operational and emissions data from facility 114 is available for centralized analytics and decision-making purposes.

In some aspects, decarbonization roadmap system 100 can manage data from multiple facilities (e.g., facility 102 and facility 114), enabling comparisons, benchmarking, and coordinated decarbonization strategies to be implemented based on a corporate or group directive. By coupling multiple monitored facilities (e.g., facility 102 and facility 114), decarbonization roadmap system 100 can provide a top-down and bottom-up analysis of GHG emissions. For example, decarbonization roadmap system 100 can evaluate individual facility-level decarbonization initiatives and enterprise-wide strategies based on cost, feasibility, and other strategic considerations.

In some aspects, the GHG emission data memory 106 stores emissions data obtained from facilities, including facility 102 and facility 114. This GHG emission data memory 106 can be implemented as a database, a cloud-based storage system, a local server, or a secure distributed ledger. In some aspects, the GHG emission data memory 106 may be coupled to a decarbonization roadmap data processor 108 (labeled “μC” in FIG. 1, generally referring to a microcontroller or microprocessor-based computation platform). In some aspects, the decarbonization roadmap data processor 108 receives emissions data, normalizes the emissions data and employs forecasting models, computational engines, and data analytics techniques to generate forward-looking emissions scenarios. The scenarios may extend to the year 2050 and consider business-as-usual (BAU) projections, potential facility expansions, operational changes, external market conditions, and internal corporate strategic targets.

In some aspects, the decarbonization roadmap data processor 108 may comprise one or more functional modules configured to analyze emissions data to forecast GHG emissions trends, evaluate the impact of decarbonization initiatives, generate MACCs, prioritize initiatives based on cost-effectiveness and feasibility, and generate implementation directives for emissions reduction strategies. For example, the decarbonization roadmap data processor 108 may include an emissions forecasting engine (e.g., Module 1), a MACC and Decarbonization Initiative Analysis Engine (e.g., Module 2), and a Group-Level Prioritization and Investment Planning Engine (Module 3).

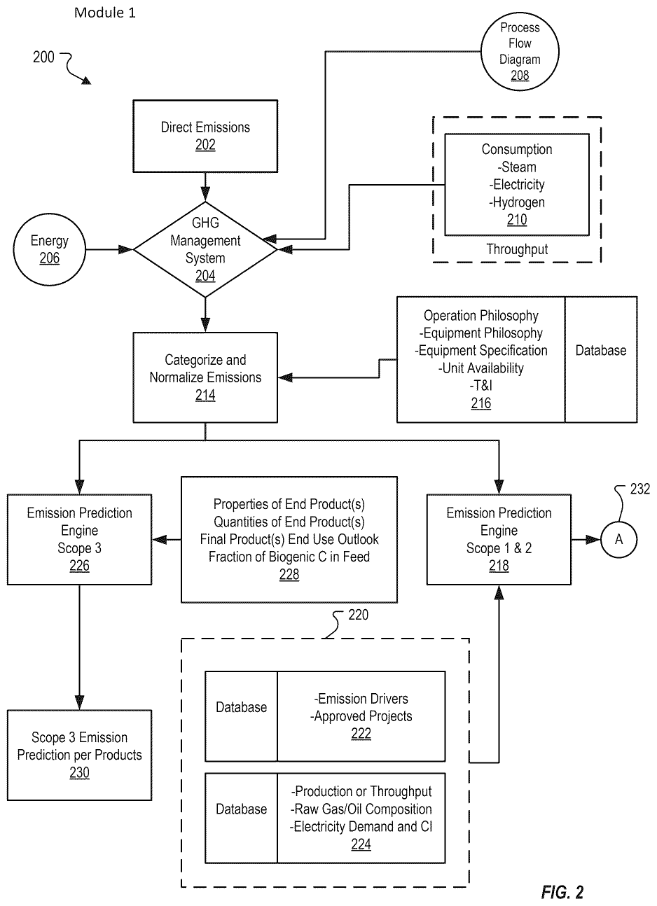

As will be further described with respect to FIG. 2, the emissions forecasting engine (e.g., Module 1) may operate on real-time data from the GHG emission data memory 106 and external outlooks and datasets, converting current operational parameters and known equipment characteristics into long-term Scope 1, 2, and possibly Scope 3 emissions forecasts. In some aspects, the forecasting process may account for potential operational disruptions, turnarounds, maintenance schedules, and expansions, normalizing the collected data to reflect expected long-term performance and equipment availability. The emissions forecasting engine may integrate internal corporate outlooks (e.g., production levels, throughput forecasts, utility price projections) and external factors (e.g., regulatory changes, commodity prices, technology availability).

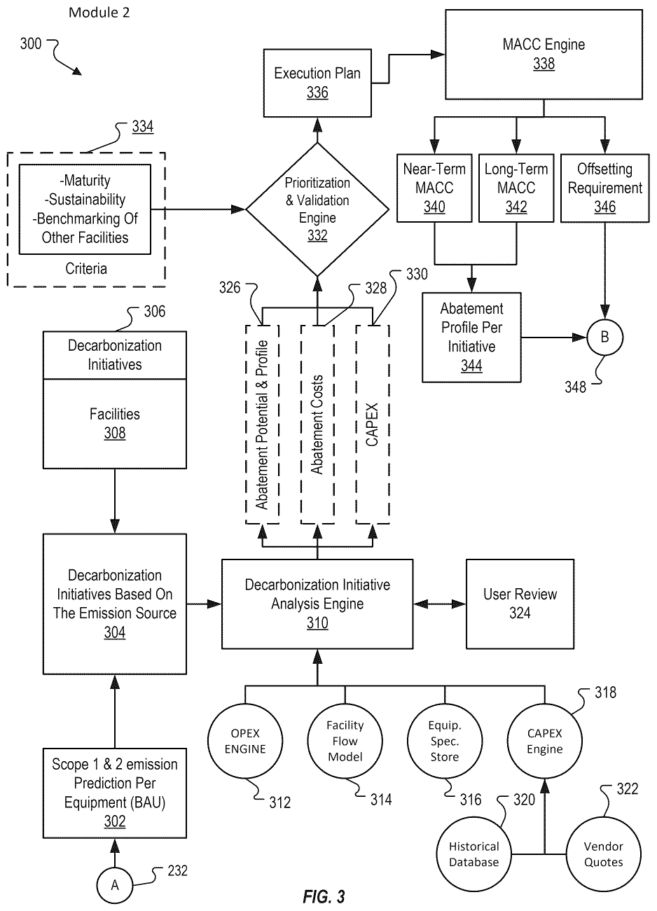

As will be further described with respect to FIG. 3, the MACC and decarbonization initiative analysis engine may utilize the emissions forecasts to identify a range of potential emissions reduction initiatives. Such initiatives may include energy efficiency improvements, flaring reduction measures, fugitive emissions detection and repair programs, low-carbon power and steam generation solutions, carbon capture, utilization, and storage (CCUS) projects, and emissions offsetting options (e.g., forestry or direct air capture offsets). By analyzing cost and emissions abatement potential at the equipment level, each initiative's abatement potential, CAPEX, operating expenditures (OPEX), and net present value (NPV) may be calculated. The MACC and decarbonization initiative analysis engine may rank initiatives by their abatement cost, enabling the generation of a cost-sorted MACC that visually illustrates the cost-effectiveness and scale of each potential intervention. In some aspects, prioritization logic may ensure that feasible, technically ready, and cost-effective decarbonization initiatives are identified.

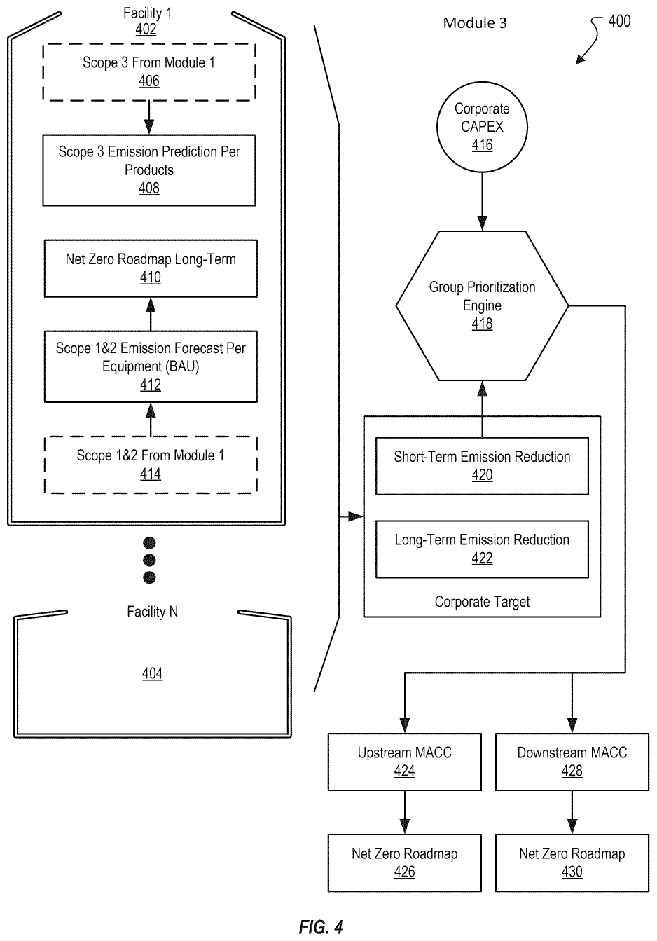

As will be further described with respect to FIG. 4, the group-level prioritization and investment planning engine may aggregate the information from multiple facilities (e.g., facility 102, facility 114) and generate corporate-level strategies once decarbonization initiatives are identified and their relative costs and benefits are established at the facility level. For example, corporate emissions reduction targets for 2035 and 2050 can be cascaded down to facility-level roadmaps. In some aspects, the group-level prioritization and investment planning engine may dynamically respond to real-time changes in underlying assumptions such as throughput, commodity prices, regulatory environments, or technology readiness. In some aspects, the group-level prioritization and investment planning engine may evaluate how modifications to corporate desires (e.g., more stringent targets) or changes in asset portfolios (e.g., acquisition or divestment of certain facilities) affect the overall decarbonization strategy and investment plan. Accordingly, by implementing scenario analysis and sensitivity testing, different configurations of initiatives can be explored such that an optimal portfolio that meets corporate objectives at minimal cost, minimal technical risk, or other relevant strategic criteria can be selected.

In some aspects, the forecasts, MACCs, and decarbonization roadmaps generated at the decarbonization roadmap data processor 108 may be provided to the emission reduction initiative output translator 110. The emission reduction initiative output translator 110 may act as an interface, presenting data in a structured format that can be understood by facility operators, corporate planners, and executive decision-makers. Some aspects of the emission reduction initiative output translator 110 can generate dashboard visualizations, implementation plans, and investment schedules that communicate how each facility or group of facilities can reach interim and long-term decarbonization targets. In some aspects, the emission reduction initiative output translator 110 may present a timeline for each initiative's implementation, expected emissions reductions over time, associated CAPEX and OPEX, and offset requirements needed to achieve net zero emissions.

As illustrated in FIG. 1, multiple transmitters and receivers may support communication between facilities and the central computation system 100. For example, transmitter 124, associated with the first facility 102, communicates over a secure data channel (wired, wireless, optical fiber, or satellite link) with receiver 126 connected to the GHG emission data memory 106 and decarbonization roadmap data processor 108. Similarly, transmitter 128 and receiver 130 may facilitate the transmission and reception of data for the second facility 114. In some aspects, data can be exchanged bidirectionally, allowing the decarbonization roadmap data processor 108 to send back recommendations, target emissions levels, or operational instructions that could be implemented at the facility level via controllers 122 and 136. In some aspects, closed-loop control strategies may be employed. For example, if the decarbonization roadmap data processor 108 detects that specific equipment is operating inefficiently or that a certain emission threshold is being approached, the decarbonization roadmap data processor 108 can send control signals that adjust operational parameters in real-time, thus nudging the facility towards an emissions reduction pathway.

In addition, decarbonization roadmap system 100 may utilize data sources relevant to all three scopes of GHG emissions. For example, decarbonization roadmap system 100 may incorporate direct (Scope 1) emissions data from on-site combustion and equipment operations at facilities such as Facility 102 and indirect (Scope 2) emissions data associated with purchased electricity, steam, or other externally sourced energy consumed by the facility. Further, decarbonization roadmap system 100 may include information related to value chain (Scope 3) emissions associated with downstream activities, such as the end-use of the facility's products. These Scope 3 emissions may be incorporated by analyzing known or forecasted product consumption patterns, transportation logistics, and other life-cycle factors influencing the facility's overall decarbonization impact.

As illustrated in FIG. 1, a controlled facility emissions system 112, associated with facility 114, provides an example of how the decarbonization roadmap system 100 can integrate a wide range of emission control technologies and operational parameters. For instance, the controlled facility emissions system 112 may involve low-carbon burners, flare gas recovery units, carbon capture technologies, or renewable energy solutions. A sensor and controller network 132 associated with facility 114 may monitor relevant operational and environmental variables in real time. Sensor 134 may measure parameters such as gas flow rates, carbon content, or capture efficiency. At the same time, controller 136 may adjust equipment setpoints or operating conditions based on the emission control logic provided by the decarbonization roadmap data processor 108.

In accordance with aspects of the present disclosure, decarbonization roadmap system 100 may be both flexible and scalable. For example, additional facilities, regardless of location, industry, or operational complexity, c, can be brought online by coupling their sensor and controller networks to the GHG emission data memory 106 and the decarbonization roadmap data processor 108. As more facilities are added, decarbonization roadmap system 100 can generate more comprehensive MACCs, identify cross-facility synergies, and optimize the allocation of capital and operational resources to meet corporate-level emissions reduction targets. For example, if one facility provides surplus carbon capture capacity, decarbonization roadmap system 100 may leverage that capability to offset emissions from another facility, adjusting overall investment and ensuring that corporate-level sustainability goals are met.

In some implementations, the decarbonization roadmap data processor 108 may utilize one or more linear programming, optimization routines, or machine learning-based predictive models. These techniques may be used to optimize constraints such as CAPEX limits, technology readiness levels, regulatory compliance deadlines, and emission intensity metrics. For instance, if a corporate target is to achieve net-zero Scope 1 and 2 emissions by 2050 without relying heavily on offsets, decarbonization roadmap system 100 may prioritize early adoption of operational improvements and carbon capture projects. Conversely, if limited CAPEX is available in the near term, decarbonization roadmap system 100 could select lower-cost initiatives first and defer capital-intensive projects until future budget conditions improve.

In addition to informing strategic decision-making at the corporate level, decarbonization roadmap system 100 enables facility-level operators and engineers to understand the impact of their day-to-day operational decisions on long-term emissions trajectories. By interfacing with the emission reduction initiative output translator 110, facility personnel can identify which initiatives offer meaningful emission reductions at low cost and implement the identified initiatives. For example, if a recommended initiative suggests replacing an outdated boiler with a high-efficiency model to lower emissions and achieve a favorable payback period, the operator at the facility can initiate that upgrade with confidence that such expenditure will further facility and corporate GHG emission targets.

Decarbonization roadmap system 100 enables iterative improvements to one or more facilities in some aspects. As new data become available from integrated facilities, the decarbonization roadmap data processor 108 can automatically update emissions forecasts, MACCs, and recommended initiatives. Changing assumptions—such as evolving regulatory conditions, technology breakthroughs in carbon capture or renewable energy, or shifts in corporate sustainability targets—can be reflected in real time.

Although FIG. 1 focuses on two facilities (102 and 114) for illustrative simplicity, the principles, methods, and architectures described herein apply to many facilities and industrial operations. The communication links and data structures used to interface facilities with the GHG emission data memory 106 and the decarbonization roadmap data processor 108 may leverage industry-standard protocols, secure communication channels, cloud-based integration services, or proprietary industrial IoT solutions. Similarly, sensors and controllers at the facility level and data storage components may vary widely depending on site-specific instrumentation, regulatory requirements, and data handling preferences.

By consolidating emissions data, forecasting future trends, identifying cost-effective reduction measures, and aligning facility-level actions with corporate-level goals, decarbonization roadmap system 100 may overcome the limitations of static, spreadsheet-based approaches, enabling a dynamic, scalable, and continuously improving solution. Decarbonization roadmap system 100 may promote informed decision-making, optimized resource allocation, and measurable progress toward net-zero emissions objectives.

Referring now to FIG. 2, an exemplary block diagram 200 illustrates additional details of the workflow and data processing steps associated with Module 1 of the decarbonization roadmap system 100 previously described in FIG. 1. In some aspects, FIG. 2 provides a more granular view of how real-time operational data, equipment-level emissions readings, and future outlook parameters feed into the generation of forward-looking Scope 1, Scope 2, and Scope 3 greenhouse gas (GHG) emissions forecasts. As previously described, the forecasting capability provides the foundation for subsequent analyses that develop MACCs and facility-level or corporate-level decarbonization roadmaps.

As depicted in FIG. 2, module 1 is configured to receive a variety of input streams related to facility operations and emissions. For example, at block 202, direct emissions data originating from on-site equipment may be received. Such equipment may include combustion sources (e.g., boilers, furnaces, turbines), flares, vents, and fugitive emission points. Such direct emissions may refer to Scope 1 sources as they are produced within the facility boundary. Energy data (block 206) is provided alongside direct emissions as a separate input stream. The energy data may include information about fuel gas consumption, steam usage, electricity demand, and hydrogen consumption. By incorporating direct emissions and energy parameters, Module 1 can more precisely connect each emission source to the operational and energy factors driving it.

In some aspects, the direct emissions data block 202 and energy data block 206 may be processed by a GHG management system 204. In some aspects, the GHG management system 204 integrates sensor readings, equipment specifications, and known emissions factors to convert raw operational signals into normalized GHG metrics (e.g., CO₂-equivalent emissions). In some aspects, the GHG management system 204 provides a unified emissions inventory as a baseline for subsequent categorization and normalization.

Downstream of the GHG management system 204, module 1 applies a categorization and normalization block 214. In some aspects, the categorization process assigns each emissions source to a relevant category, such as combustion, flaring, venting, fugitives, or utility consumption. In some aspects, this ensures that emissions are quantified and organized into meaningful groups that facilitate scenario analysis and grouped decarbonization strategies. During normalization, module 1 may adjust for temporary operational anomalies—such as planned maintenance shutdowns, unplanned outages, or abnormal throughput fluctuations. Accordingly, the resulting GHG emissions baseline can reflect representative long-term operating conditions rather than short-term disruptions.

Module 1 may access a database (block 216) that describes a facility's operational philosophy, equipment specifications, and unit availability profiles to support categorization and normalization. This database may store information on each unit's expected long-term operating regime, including nominal throughput levels, unit-level reliability metrics, and planned turnaround schedules (T&I). By leveraging these operational parameters, the categorization and normalization block 214 refines the GHG emissions baseline to align with realistic operating conditions at the equipment level.

In addition to direct emissions and energy data, Module 1 may also incorporate consumption block 210. in some aspects, consumption block 210 provides data regarding the facility's consumption of externally sourced utilities such as electricity, steam, and hydrogen. The consumption block may provide operational parameters (e.g., the amount of electricity or steam purchased) that, when combined with emission factors and other inputs within the GHG management system 204, enable module 1 to determine the resulting Scope 2 emissions. In some aspects, some of the utilities from consumption block 210 may be generated on-site, whereas others are purchased externally. Incorporating data from the consumption block 210 helps to ensure that both Scope 1 (e.g., on-site combustion) and Scope 2 (e.g., purchased electricity) emissions are captured and can be forecasted.

Once a representative baseline has been established, as depicted in FIG. 2, two principal pathways for emissions forecasting may be used. One path leads to the emission prediction engine 218 for Scope 1 & 2. The emission prediction engine 218 may use the categorized and normalized baseline as a starting point to integrate future outlooks—such as equipment capacity expansions, efficiency improvement projects, changes in electricity carbon intensity, or shifts in fuel composition—drawn from dedicated databases 220, 222, and 224. For example, a database of “emission drivers” and “approved projects” (block 222) may store information on upcoming debottlenecking activities, new low-carbon boilers, or process optimizations that may influence future emissions. Another database (block 224) may store production or throughput forecasts, raw gas or oil composition changes, and evolving electricity demand profiles. The emission prediction engine 218 can generate long-range Scope 1 & 2 emissions forecasts by merging these forward-looking inputs.

A second pathway within Module 1 addresses Scope 3 emissions via the emission prediction engine for 226. As previously mentioned, Scope 3 emissions refer to emissions occurring outside the facility's direct operations, such as those associated with the downstream use of the facility's end products. To forecast these emissions, the emission prediction engine 226 draws upon a dedicated dataset (block 228) describing the facility's final products'properties, quantities, and end-use applications. This may include, for example, the fraction of biogenic carbon in the feed, product composition, and anticipated product consumption patterns. By correlating product-specific data with recognized emissions factors and end-use scenarios, the emission prediction engine 226 can forecast downstream emissions (block 230) on a product-by-product basis.

By employing the Scope 1 & 2 emission prediction engines 218 and the emission prediction engine 226, FIG. 2 illustrates how module 1 may generate comprehensive emissions forecasts that cover a range of relevant emissions categories. The output of these engines may be updated dynamically as input parameters change. For example, suppose production levels are revised, or an additional efficiency project is approved. In that case, the engines can recalculate their forecasts in real-time, ensuring that all subsequent modules (e.g., those generating MACCs and decarbonization roadmaps) can access the most current and accurate emissions outlook.

Referring to FIG. 3, block diagram 300 illustrates additional detail of workflow and data processing steps associated with Module 2 of the decarbonization roadmap system 100 previously described in FIG. 1. In particular, aspects of FIG. 3 expand upon how various decarbonization initiatives may be identified, analyzed, validated, prioritized, and ultimately integrated into MACCs, thereby enabling the development of a cost-effective and feasible decarbonization roadmap for one or more facilities. In some aspects, FIG. 3 further depicts the logic flow and data interconnections among (i) upstream emissions predictions, (ii) the generation of decarbonization initiatives, (iii) the analysis and computation of technical and financial metrics (e.g., abatement potential and capital expenditures), (iv) user review steps, (v) prioritization and validation processes, (vi) MACC computation for both near-term and long-term horizons, and (vii) an offsetting requirement determination.

As previously described with respect to FIG. 1 and FIG. 2, real-time data from sensors and operational logs may be integrated with historical and projected operational parameters to forecast future emissions profiles (e.g., to 2035 or 2050) for each facility and/or organization equipment. The forecasted emissions data, generated at the equipment level, is input to the subsequent emissions calculating steps. Upstream of the MACC analysis and before identifying cost-effective pathways, Module 2 may evaluate a broad portfolio of potential decarbonization initiatives that could be deployed at each facility. Such initiatives may be derived from multiple sources and categories.

In some examples, the carbonization initiatives based on the emission source block 304 may represent a logic module configured to screen and propose candidate initiatives targeted to emission sources identified in the BAU forecast. For instance, if a substantial fraction of emissions originate from gas turbines, Module 2 may propose a decarbonization initiative including one or more of a high-efficiency turbine retrofit, hybrid electrification strategy, or integration of low-carbon fuels. Similarly, if a significant share of emissions stems from flaring or process vents, Module 2 may highlight flare gas recovery systems, fugitive leak detection and repair (LDAR) programs, or carbon capture opportunities as proposed decarbonization initiatives.

In some aspects, decarbonization initiatives 306 may represent a library, database, or catalog of known decarbonization initiatives drawn from internal and external references. Decarbonization initiatives 306 may be a dynamically maintained repository of pre-qualified decarbonization measures previously considered or implemented at one or more other facilities of the organization. Decarbonization initiatives 306 may also incorporate new and emerging technologies from industry research, academic studies, pilot tests, or technology scouting activities. Each listed decarbonization initiative may include metadata such as expected emissions reduction potential, maturity level, CAPEX/OPEX estimates, and technology readiness levels (TRLs).

To further refine and contextualize the suite of candidate initiatives, facilities 308 may represent a specialized filtering or referencing mechanism tailored to similar assets of the same owner/operator. Module 2 can leverage lessons learned, vendor performance data, proven engineering solutions, and synergies between similar assets by considering solutions implemented at sister facilities. In some examples, Module 2 ensures that recommended initiatives are technically feasible and reflect best practices, internal standards, and benchmarks established within the organization's existing portfolio.

The output from elements 304, 306, and 308 converge into a collection of prospective decarbonization initiatives for a specific facility and associated emission sources. These decarbonization initiatives may be provided to the decarbonization initiative analysis engine 310. In some aspects, the decarbonization initiative analysis engine 310 evaluates each decarbonization initiative's technical and economic characteristics. In particular, the decarbonization initiative analysis engine 310 may quantify the abatement potential per decarbonization initiative and determine associated CAPEXs, abatement costs, and other financial metrics. The analysis performed by the decarbonization initiative analysis engine 310 may incorporate outputs from one or more tools and data sources (elements 312, 314, 316, 318, 320, 322) as further described below.

In some aspects, the OPEX engine 312 may provide OPEX estimates for each candidate decarbonization initiative. For example, the OPEX engine 312 may refine an economic profile associated with each prospective decarbonization initiative based on one or more maintenance requirements, energy consumption changes, catalyst costs, spare parts inventories, and labor expenses. This ensures that a full lifecycle cost may be considered for each decarbonization initiative rather than simply the initial CAPEX.

In some aspects, the facility flow model 314 may represent a fundamental engineering model of the facility's process units, utility systems, and material/energy balances. By incorporating thermodynamic models, hydraulic calculations, and flow simulations, the facility flow model 314 may predict how changes resulting from a decarbonization initiative (e.g., altering a heat exchanger, upgrading boiler efficiency, or changing the fuel type in a turbine) may affect the facility's overall performance. The facility flow model 314 may ensure that the abatement potential is accurately computed, considering process interactions, integration constraints, and potential secondary impacts on throughput or product yields.

In some aspects, the equipment specification store 316 may provide detailed technical specifications, performance curves, nameplate capacities, and operational envelopes for each relevant piece of equipment at a facility. When evaluating a decarbonization initiative that involves retrofitting or replacing equipment, the equipment specification store 316 may ensure that the design capacities, mechanical constraints, and performance characteristics are respected. The equipment specification store 316 may be updated as new equipment is installed, specifications change, or vendors supply updated datasheets.

In some embodiments, the CAPEX engine 318 may complement the OPEX engine 312 by assessing upfront capital investments required for each decarbonization initiative. Relying on information from the historical database 320 and vendor quotes 322, the CAPEX engine 318 may refine cost estimates, ensure accuracy, and account for project-specific conditions such as location factors, site integration complexity, labor costs, and material prices. Using historical data from the historical database 320 and real-time vendor information from vendor quotes 322, the CAPEX engine 318 can generate realistic cost estimates with reduced uncertainty to facilitate improved decision-making capabilities.

In some aspects, the historical database 320 and the vendor quotes 322 may feed into both the CAPEX and OPEX estimations and overall cost modeling. The historical database 320 may store empirical data from previously completed projects, past retrofits, or implemented decarbonization initiatives, providing a benchmark to validate cost and performance assumptions. Vendor quotes 322 may deliver current pricing, lead times, warranties, and service agreements, ensuring that the initiatives reflect current market conditions rather than outdated assumptions.

The integrated results from the decarbonization initiative analysis engine 310 may generate outputs including abatement potential and profile 326; abatement costs 328, and CAPEX 330. The abatement potential and profile 326 may provide emissions reduction potential (e.g., ktCO₂/yr), and the abatement costs 328 may provide a cost per unit abatement (e.g., $/tCO₂). In some examples, associated investment metrics (NPV, IRR, payback period) may also be provided. The abatement profile per initiative 344 describes how the emissions reductions unfold over time, considering technology ramp-up, project implementation schedules, degradation factors, and maintenance cycles.

In some aspects, a user review stage 324 may provide a platform for facility engineers, corporate planners, or subject matter experts to examine the proposed decarbonization initiatives, validate assumptions, verify data integrity, and, if necessary, override or adjust certain parameters based on expert judgment. The user review stage 324 may help to ensure that human insights, practical considerations, and domain-specific knowledge are integrated into the decision-making process, rather than relying solely on automated computations.

In some aspects, the refined results may be provided to the prioritization & validation engine 332, incorporating automated calculations and expert feedback. The prioritization & validation engine 332 may evaluate the viability and desirability of each decarbonization initiative against multiple criteria. These criteria may be sourced from a dedicated criteria database 334, which may include considerations such as technology readiness, strategic alignment with corporate sustainability goals, maturity of the solution in the market, benchmarking against other facilities, external policy considerations, risk tolerance, local regulations, and supply chain complexities.

By applying the criteria from the criteria database 334, the prioritization & validation engine 332 may rank decarbonization initiatives according to their cost-effectiveness, feasibility, risk profile, and strategic value. For example, a decarbonization initiative projected to reduce GHG emissions at a low cost and with proven technology may rank higher than a decarbonization initiative that provides marginal reductions at a high capital cost. In some aspects, synergy may be considered, where synergy may refer to circumstances where certain decarbonization initiatives complement each other, resulting in greater cumulative benefits than if implemented individually. The prioritization and validation engine 332 thus integrates quantitative data with qualitative judgments to produce a coherent shortlist of prioritized initiatives.

Following the prioritization and validation engine 332, an execution plan 336 may be generated. In some aspects, the execution plan 336 reflects a synthesized roadmap of selected initiatives, their intended implementation timelines, dependencies, required budget allocations, and offsets or complementary measures. The execution plan 336 may also be provided to the MACC engine 338.

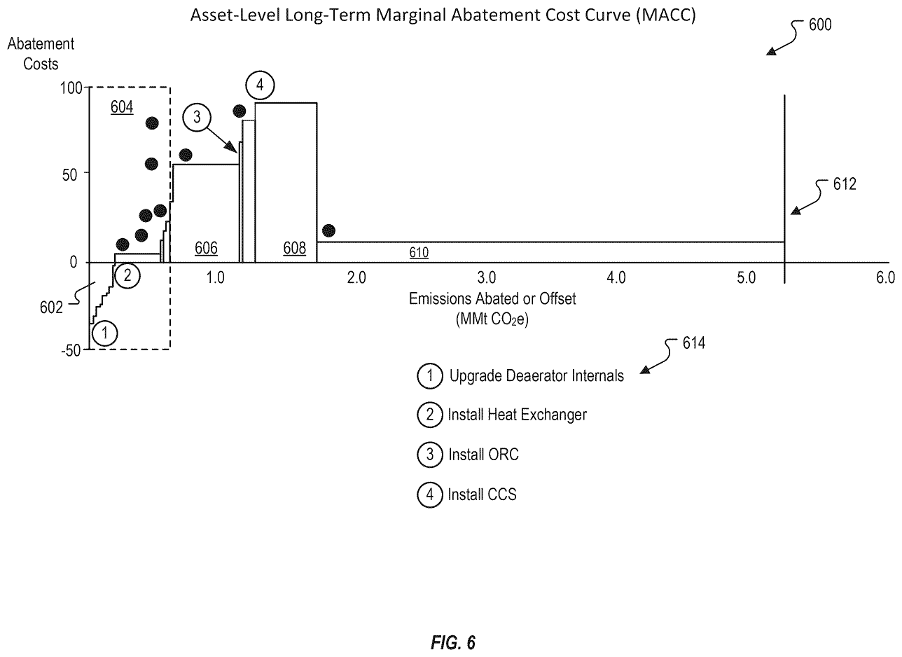

In some aspects, the MACC engine 338 may generate the marginal abatement cost curves, translating the ranked decarbonization initiative portfolio into a visual and analytical tool. In some aspects, these MACCs illustrate (e.g., as depicted in FIG. 6) the cost per ton of reduced emissions on the vertical axis and the cumulative emissions abatement on the horizontal axis. In some aspects, the MACC engine 338 may generate near-term MACC 340 and long-term MACC 342. The near-term MACC 340 may focus on a mid-range target year (e.g., 2035), capturing measures that can be implemented relatively quickly and at a lower cost, addressing interim corporate reduction targets. The long-term MACC 342, on the other hand, might consider the horizon year (e.g., 2050), reflecting the broader, more challenging decarbonization measures required to achieve net-zero ambitions. By comparing the near-term MACC 340 and long-term MACC 342, decision-makers can better understand how incremental investments build toward emissions goals over short, medium, and longer timeframes.

In some aspects, certain residual emissions may not be able to be abated through on-site measures alone. Therefore, module 1 may also compute an offsetting requirement 346. The offsetting requirement 346 may evaluate how much CO₂-equivalents remain unabated after implementing feasible decarbonization initiatives and meeting certain cost or feasibility constraints. In some aspects, offsetting could involve nature-based solutions (e.g., afforestation) or engineered solutions (e.g., direct air capture with permanent sequestration). The offsetting requirement 346 may be used to provide decision-makers with a more complete picture of the residual emissions gap and the potential need to procure offsets or invest in external mitigation projects.

In some aspects, the abatement profile per initiative 344 represents a feedback loop that provides a cumulative understanding of how each selected decarbonization initiative contributes to an overall decarbonization trajectory. By examining these profiles individually and collectively, planners can confirm that the chosen initiatives align with the corporate strategy and facility-level targets and can adjust the execution plan 336 if necessary.

Module 2 may apply machine learning or another optimization algorithm within the prioritization & validation engine 332 in some embodiments. In other embodiments, the criteria block 334 may include weighted scoring methodologies reflecting stakeholder priorities and corporate risk appetite. Similarly, the offsetting requirement 346 may integrate pricing information for carbon offsets to guide decisions on whether additional on-site initiatives are more cost-effective than purchasing offsets.

FIG. 4 depicts a block diagram illustrating details directed to how facility-level emissions forecasts, decarbonization initiatives, and marginal abatement cost curves (MACCs) from modules 1 and 2 are integrated and scaled up to the corporate level to produce short-term and long-term emissions reduction targets, corporate-level MACCs, and net zero roadmaps, in accordance with aspects of the present disclosure. In some aspects, FIG. 4 provides a top-down view of how multiple facilities, each with its own emissions profile and decarbonization strategies, feed into a centralized group prioritization engine 418. This group prioritization engine 418, coupled with corporate-level considerations such as CAPEX constraints, technology readiness, and strategic objectives, may enable the development of a decarbonization roadmap that achieves both interim and long-term targets (e.g., a 2035 reduction milestone and a 2050 net zero ambition).

FIG. 4 depicts a plurality of facilities, including facility 1 402. Facility 1 402 may have undergone the processes described with respect to module 1 (emissions forecasting) and module 2 (MACC generation and decarbonization initiative prioritization). As a result, facility 1 402 may produce scope 2 emissions from module 1 404 representing the electricity, steam, or other utilities purchased externally and consumed by facility 1 402. Module 1 generates a forward-looking forecast of scope 2 GHG emissions at the equipment or systems level under a BAU scenario by incorporating the appropriate GHG emissions factors. These forecasts reflect long-term assumptions about equipment availability, production throughput, and externally sourced energy supplies. As previously described, the scope 3 emission prediction per product 406 for facility 1 402 may forecast downstream emissions associated with the end-use of its (e.g., Facility 1's) products. These downstream emissions forecasts can be integrated into the corporate-level strategy, ensuring that scope 3 considerations are neither overlooked nor siloed.

In some aspects, the net zero roadmap long-term 410 may be based on module 2's analyses. For example, facility 1 402 can generate a preliminary long-term decarbonization roadmap that aligns with corporate targets (such as achieving net zero by 2050). This roadmap may consist of multiple decarbonization initiatives (e.g., energy efficiency measures, carbon capture projects, renewable energy integration, and offsetting strategies) sequenced and prioritized according to their marginal abatement costs, feasibility, and alignment with strategic objectives.

In some aspects, the scope 1 & 2 emission forecast per equipment (BAU) 414 may be based on the normalized GHG emissions baseline and operational parameters obtained from module 1. In some aspects, facility 1 402 may forecast its equipment-level scope 1 & 2 emissions to 2050 under a BAU scenario. In some aspects, this forecast may reflect assumptions about throughput, maintenance schedules, technical constraints, and future operational philosophies.

In some aspects, scope 1 & 2 emission forecast per equipment (BAU) 412 may output the baseline and forecasted scope 1 & 2 emissions generated by module 1. This data informs the selection of decarbonization initiatives and the calculation of MACCs, ensuring that the facility-level roadmap first addresses the largest or most cost-effective emissions sources. Although FIG. 4 depicts facility 1 402, similar outputs may be generated for additional facilities, represented collectively as facility N 404. In some aspects, each facility may undergo the same process: real-time data ingestion, normalization, forecasting, initiative identification, and MACC generation, resulting in a portfolio of facility-level decarbonization roadmaps, each with its unique combination of decarbonization initiatives, costs, and emissions reduction timelines.

The group prioritization engine 418 may integrate the individual facility-level outputs into a cohesive corporate-level strategy. The group prioritization engine 418 may comprise one or more algorithms and one or more decision-making frameworks designed to reconcile corporate constraints with facility-level inputs. By considering the aggregated data from multiple facilities, the group prioritization engine 418 can identify which initiatives deliver the greatest emissions reductions at the lowest cost, prioritize projects, and minimize the total required CAPEX.

In some aspects, the group prioritization engine 418 receives corporate CAPEX 416, referring to the total capital expenditure budget available to support decarbonization initiatives. Corporate CAPEX 416 may be set by executive management, reflecting investment priorities, market conditions, and shareholder expectations. By processing the aggregated MACCs from multiple facilities, the group prioritization engine 418 can first select the most cost-effective decarbonization initiatives, ensuring that corporate-level decarbonization targets can be met with minimal CAPEX outlay and maximum financial efficiency. The group prioritization engine 418 may also generate outputs aligned with corporate-level emissions reduction timelines. For instance, some organizations have interim targets (e.g., a 15% reduction by 2035) and long-term targets (e.g., net zero by 2050). Therefore, two streams of emissions reduction strategies may be developed. A short-term emission reduction 420 may represent the set of initiatives, policies, and measures that can be implemented in the near-to-medium term (e.g., by 2035) to meet interim corporate targets. Such short-term strategies might focus on the most readily implementable and cost-effective solutions, such as energy efficiency upgrades, flaring reduction, or moderate renewable energy adoption. In some aspects, the long-term emission reduction 422 may represent strategies necessary to achieve more ambitious, long-term goals, such as net zero by 2050. Long-term strategies may include advanced technologies still under development, large-scale carbon capture and storage (CCS), comprehensive renewable energy integration, and/or strategic offsets. Such measures may require longer lead times, larger investments, or more advanced planning.

In some aspects, once the group prioritization engine 418 finalizes the set of prioritized decarbonization initiatives across all facilities, the group prioritization engine 418 may produce corporate-level MACCs and decarbonization roadmaps. As depicted in FIG. 4, the Upstream MACC 424 may focus on emissions sources and abatement opportunities related to the company's upstream operations (e.g., oil and gas extraction, field operations, initial processing, and handling of primary feedstocks). The downstream MACC 426 may focus on refining, petrochemicals, distribution, product end-use, and other downstream operational segments. By separating upstream and downstream MACCs, a company can better understand where the largest and most cost-effective GHG reduction opportunities lie within a value chain and how decisions in one segment may influence another.

In addition to generating separate MACCs, system 400 may generate net-zero roadmaps 430 and 432 at the corporate level. In some aspects, the net zero roadmaps may integrate insights from module 1 (emissions forecasting), module 2 (facility-level MACCs and initiatives), the group prioritization engine 418, corporate CAPEX 416 constraints, and other strategic priorities. The net-zero roadmaps 430 and net-zero roadmaps 432 may represent different scenarios or strategies, where one might focus on achieving net zero with minimal reliance on offsets, while another might consider a mix of abatement measures and offsets. Alternatively, these roadmaps may reflect different business units, product lines, or geographic regions, each requiring a tailored approach to decarbonization.

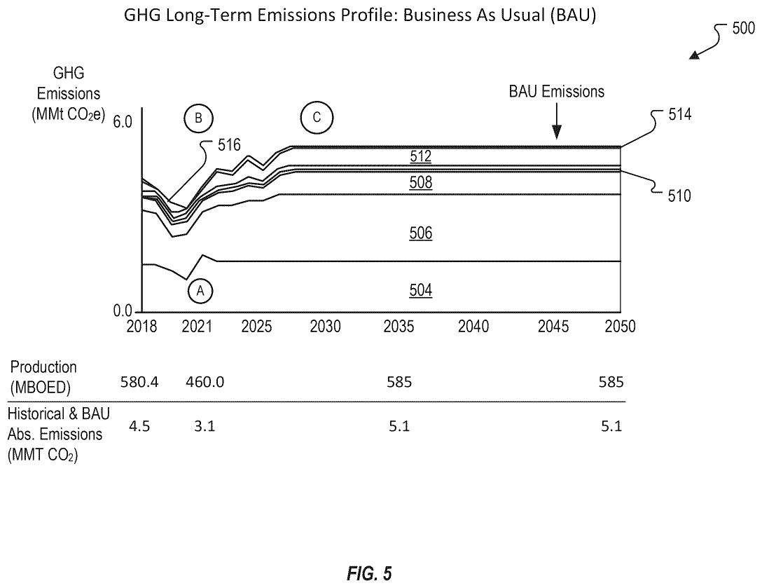

Referring now to FIG. 5, illustrated is an example graphical representation 500 of a greenhouse gas (GHG) long-term emissions profile under a business-as-usual (BAU) scenario for at least one industrial facility in accordance with aspects of the present disclosure. FIG. 5 visually depicts how GHG emissions may evolve from a historical baseline year through an extended forecast horizon (e.g., from about 2018 to about 2050) without additional decarbonization measures. This graphical depiction 500 may be generated by the decarbonization roadmap system 100 described herein.

In FIG. 5, the vertical axis represents GHG emissions expressed in million metric tons of CO₂-equivalent (MMt CO₂e), while the horizontal axis represents time, extending over multiple decades (e.g., from about 2018 through about 2050). The data displayed in FIG. 5 can be facility-specific, enterprise-wide, or representative of various facilities aggregated by the system. Major operational events, expansions, and known adjustments to facility processes are incorporated along the timeline to produce an emissions profile that accurately reflects evolving conditions under BAU assumptions. The illustrated profile in FIG. 5 may comprise multiple GHG emissions trajectories or layers, each indicated by reference numerals (e.g., 504, 506, 508, 510, 512, 514, 516) corresponding to different GHG emissions categories. For example, baseline emissions categories might include scope 2 emissions 504, heating emissions 506, boiler emissions 508, other combustion emissions 510, venting emissions 512, flaring emissions 514, and fugitive emissions 516. Each line or band represents one emissions source category or a cumulative total. Over time, changes in production levels, equipment efficiency, operating conditions, and availability metrics are reflected. These changes may be integrated from multiple data sources, including module 1's forecasting engine and associated operational databases.

Strategic reference points A, B, and C indicate the emissions profile at specific years. These reference points may correspond to known operational changes or projects. For example, point A may represent the replacement of steam turbine generators with more efficient technology, point B may represent the startup of a clean fuels project expected to alter emissions factors or product slates, and point C may represent a forecasted production increase or another operational milestone that influences baseline emissions. Each of these points can either increase or decrease the forecasted BAU emissions trajectory and is incorporated into the underlying computations performed by the system.

FIG. 5 also depicts exemplary production metrics associated with the facility (e.g., Millions of Barrels of Oil Equivalent per Day, MBOED) as well as historical and forecasted BAU absolute emissions. These numerical values may provide context to the relative emissions performance of the facility, enabling a direct comparison between GHG emissions and operational throughput. These data points may support different scenario analyses, as changes to throughput assumptions may directly alter the BAU forecast.

FIG. 6 illustrates an example asset-level long-term MACC 600, as generated by module 2 and, in some configurations, integrated with module 3 of a decarbonization roadmap system in accordance with examples of the present disclosure. FIG. 6 visually represents a series of decarbonization initiatives plotted against their respective abatement costs (vertical axis) and potential emissions abatement or offset (horizontal axis). Each decarbonization may be associated with a segment or block indicating the cost per metric ton of CO₂-equivalent (CO₂e) reduced or avoided and the total cumulative abatement potential realized if the initiative is implemented.

In FIG. 6, the vertical axis indicates the marginal abatement cost in terms of cost per ton of CO₂e (e.g., $/tCO₂e). Values below zero on the vertical axis indicate initiatives that are cost-negative, meaning they provide net positive financial returns while reducing emissions. Values above zero represent initiatives that require net expenditures to achieve emissions reductions. The horizontal axis of FIG. 6 represents cumulative emissions abated or offset (e.g., MMt CO₂e), measured from zero on the left to a defined upper limit on the right, corresponding to progressively larger portfolios of decarbonization initiatives implemented at the asset level.

As depicted, the MACC 600 may include various emission sources 602, 604, 606, and 608. Certain initiatives, indicated by reference numerals (1), (2), (3), and (4), are exemplary measures identified and analyzed by the decarbonization roadmap data processor. These initiatives may be drawn from the database of potential decarbonization measures described previously. For example, initiative (1) may refer to “Upgrade Deaerator Internals,” which may yield immediate operational efficiencies, resulting in negative or very low marginal abatement costs. Initiative (2), labeled “Install Heat Exchanger,” may offer moderate abatement at near-neutral costs, potentially appearing as a small bar segment at or slightly above zero. Initiative (3), “Install ORC,” and initiative (4), “Install CCS,” may yield higher levels of emissions abatement but at progressively higher abatement costs, as depicted by their respective blocks on the MACC extending upward on the vertical axis. By visually stacking these initiatives, the MACC 600 allows decision-makers to quickly ascertain which measures deliver the most cost-effective reductions, how each initiative contributes to the overall abatement portfolio, and the relative position of each initiative, among others considered. A vertical marker 612 may represent a corporate target or a scenario such as net zero emissions. Initiatives to the left of marker 612 may be sufficient to meet interim or strategic targets (e.g., a 2035 intensity reduction goal), while achieving net zero may require additional measures, including offsets or more expensive technologies to the right of marker 612.

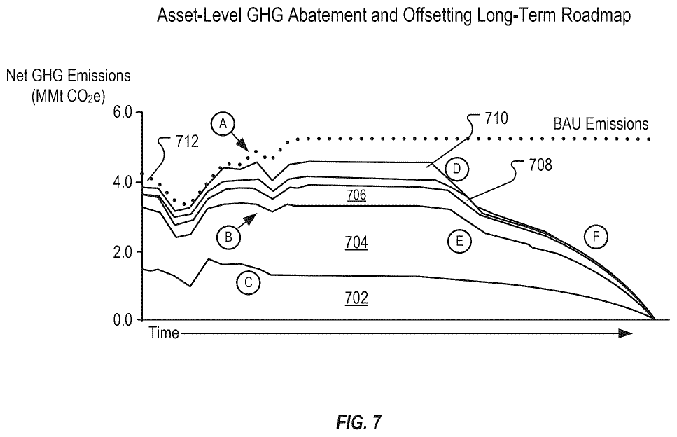

FIG. 7 illustrates an exemplary long-term roadmap 700 for asset-level greenhouse gas (GHG) abatement and offsetting in accordance with aspects of the present disclosure. In some implementations, the roadmap 700, generated by one or more of the modules described above (e.g., modules 1 and 2), may be further optimized and integrated at the group or corporate level (e.g., module 3) to ensure alignment with enterprise-level decarbonization targets and cost constraints. The vertical axis represents net GHG emissions (MMt CO₂e) over an extended time horizon, and the horizontal axis represents time. The dotted line 710 depicts the projected business-as-usual (BAU) emissions trajectory without decarbonization initiatives. By contrast, the solid lines below BAU represent a series of emissions profiles after implementing selected abatement and offsetting measures.

In some aspects, the lowest emissions trajectory, 702, represents the cumulative effect of a fully implemented portfolio of decarbonization initiatives, culminating in near net-zero GHG emissions by a specified target year (e.g., 2050). Intermediate trajectories, such as lines 704, 706, 708, and 712, illustrate incremental improvements realized by implementing subsets of decarbonization initiatives sequentially or staged. Each profile thereby shows how progressive deployment of measures reduces net GHG emissions over time compared to the BAU scenario 710.

Reference markers A, B, C, D, E, and F denote milestones or the introduction of specific categories of decarbonization initiatives at the asset level. For example, marker A may represent the initial deployment of short-term energy efficiency measures. Such measures can reduce direct combustion-related emissions (scope 1), shifting the emissions trajectory downward. Marker B may correspond to a multi-year program to upgrade fired heaters with more efficient, lower-emission technologies. This initiative further reduces direct emissions associated with process heating operations and is reflected in the emissions profile stabilizing at a lower level than before marker B.

Marker C may represent the acquisition and application of Renewable Energy Certificates (RECs) to abate scope 2 emissions associated with third-party power imports. As these RECs effectively reduce the carbon intensity of the purchased electricity, the net GHG emissions at the facility level decline further. Marker D may correspond to the startup of carbon capture and storage (CCS) systems, enabling the removal and sequestration of CO₂ from flue gases or process streams, resulting in a substantive reduction in net GHG emissions.

Marker E may indicate a subsequent phase in which selected fired heaters are electrified and powered by low-carbon electricity, complemented by additional RECs or similar instruments. This transition reduces reliance on carbon-intensive fuels, further lowering emissions. Finally, marker F may reflect the offsetting of residual emissions through approved offset mechanisms, nature-based solutions, or engineered carbon removal technologies. By applying these offset measures, the facility can achieve near net-zero emissions, represented by the lowest emissions trajectory, 702.

By reviewing FIG. 7, facility-level engineers, corporate planners, and decision-makers can visualize how each category of abatement and offsetting measure contributes to a progressive decrease in net GHG emissions. Moreover, FIG. 7 depicts the interplay between multiple initiatives, their phasing, and the resulting collective impact on achieving interim and long-term decarbonization targets. This integrated, time-sequenced approach allows for strategic prioritization of initiatives, optimization of capital expenditures, and effective alignment of asset-level actions with corporate-level sustainability commitments.

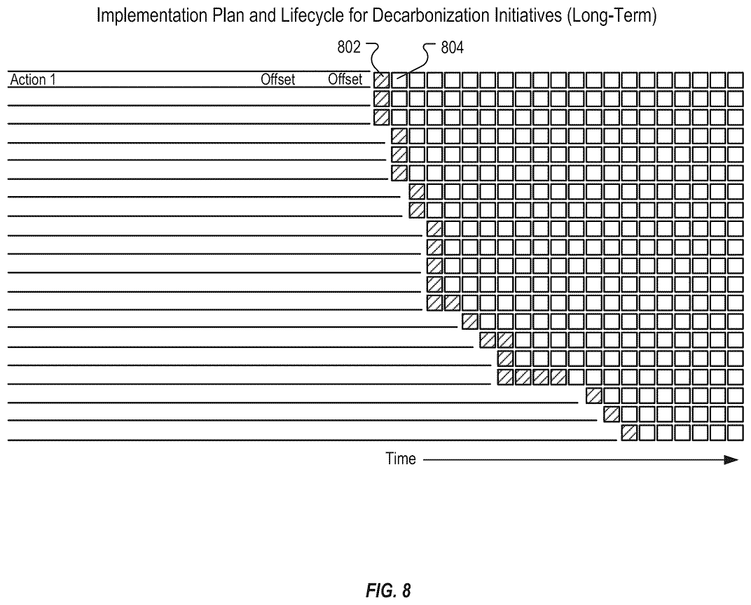

FIG. 8 provides a schematic representation of a long-term implementation plan and lifecycle 800 for selected decarbonization initiatives at the facility and/or corporate level in accordance with aspects of the present disclosure. The horizontal axis represents time, extending from the near term through a target future horizon (e.g., 2035 or 2050), and the vertical dimension corresponds to a series of decarbonization initiatives or actions. Each row in FIG. 8 aligns with a specific initiative identified and prioritized by the above processes (e.g., via modules 1, 2, and 3). The initiatives may include, for example, upgrading equipment to improve energy efficiency, integrating low-carbon power sources, implementing carbon capture and storage (CCS) systems, or applying renewable energy certificates (RECs) to abate scope 2 emissions.

Each square, such as those indicated by reference numerals 802 and 804, denotes a discrete time interval (e.g., one year) during which the corresponding initiative is implemented, operated, and/or offset emissions. The progression of filled or shaded squares from left to right visually depicts the transition from planning and execution (e.g., feasibility assessments, engineering design, construction, and commissioning) to steady-state operation and maintenance phases. Over time, the relative proportion of shaded squares may decrease as capital-intensive activities conclude and the initiative shifts to routine operation.

Within FIG. 8, certain initiatives may incorporate offsetting strategies near the later stages of the timeline to address residual emissions that on-site measures cannot eliminate. For example, offsets may be introduced after implementing energy efficiency measures, equipment electrification, or CCS installations. By layering offsets, timeline illustrates how a portfolio of initiatives evolves, converging toward lower net GHG emissions and achieving interim and long-term decarbonization targets.

By reviewing FIG. 8, facility planners, corporate decision-makers, and stakeholders can visualize the cumulative effect of the selected initiatives and their timing, phasing, and interactions. This structured visualization supports strategic investment decisions, resource allocation, and scenario analysis. For instance, if external conditions or corporate directives change (e.g., shifts in budget allocations or tighter emissions reduction targets), FIG. 8 can be updated accordingly, enabling a dynamic, data-driven approach to effective long-term decarbonization planning.

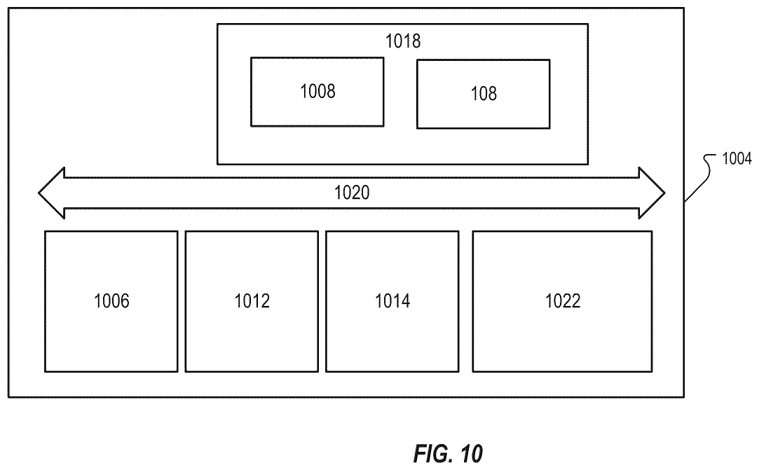

In one aspect, method 900, or any aspect related to it, may be performed by an apparatus, such as processing decarbonization roadmap system 1000 of FIG. 10, which includes various components operable, configured, or adapted to perform the method 900.

Method 900 begins at 902 with obtaining, by at least one sensor coupled to a first network, greenhouse gas (GHG) emissions data associated with equipment of the at least one industrial facility. In some aspects, the GHG emissions data includes GHG emission metrics associated with two or more GHG emission types comprising at least one of combustion, venting, flaring, fugitives, and utility consumption.

Method 900 proceeds to 904 with storing the obtained GHG emissions data. In some aspects of method 900, the obtained GHG emissions data is stored in a GHG emission data memory.

Method 900 proceeds to 906 with executing decarbonization model data processing instructions. In some aspects of method 900, the decarbonization model data processing instructions are executed by a decarbonization roadmap data processor configured with a memory component, where the steps comprise: forecasting GHG emissions for the at least one industrial facility under a business-as-usual (BAU) scenario using the GHG emissions data, wherein the forecast is for a defined timeframe; categorizing elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources; receiving at least one decarbonization initiative, the at least one decarbonization initiative comprising at least one of an energy efficiency measure, a carbon capture and storage initiative, or a GHG emissions offsetting initiative; identifying one or more of the received decarbonization initiatives applicable to the at least two emissions scopes, wherein the identified one or more decarbonization initiatives are selected based on the GHG emissions sources identified in the emissions data; generating MACCs for the identified one or more decarbonization initiatives, wherein the MACCs include at least one GHG emission reduction metric, at least one associated financial metric including at least one of a capital expenditure, operational expenditure, or lifecycle costs, and at least one implementation metric based on at least one of implementation feasibility or an implementation timeframe; generating one or more implementation directives including at least one of an operational control parameter, a schedule for execution of the identified decarbonization initiative, or a decarbonization roadmap visualization; and communicating the one or more implementation directives to an emission reduction initiative output translator.

Method 900 then ends at step 908 with implanting one or more implementation directives. In some aspects of method 900, implementing the one or more implementation directives includes implementing, by a controlled facility emissions system in communication with the emission reduction initiative output translator, the one or more implementation directives by performing at least one of: adjusting emissions control devices of the at least one industrial facility, modifying an operating parameter of at least one renewable energy system of the at least one industrial facility, or modifying an operational parameter of equipment of the at least one industrial facility.

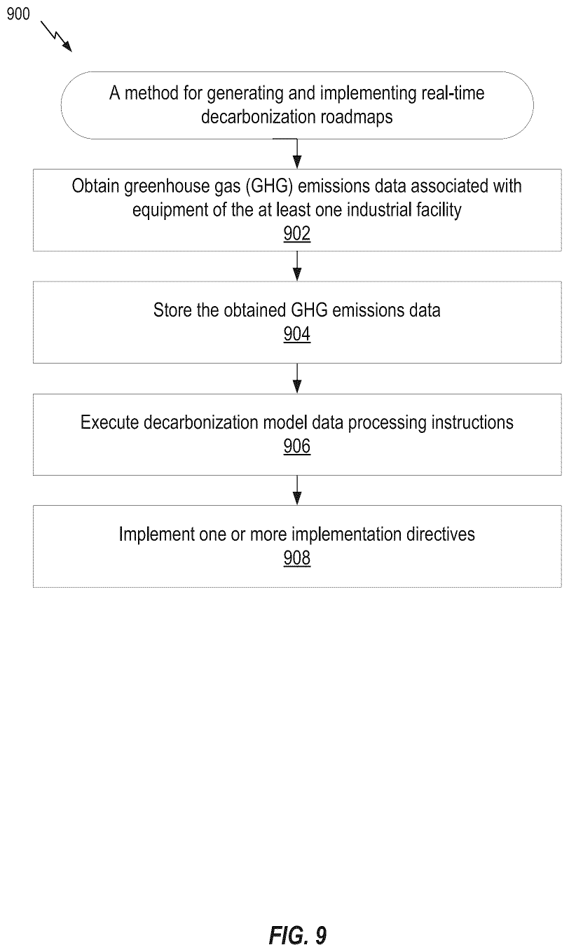

Note that FIG. 9 is just one example of a method, and other methods including fewer, additional, or alternative steps are possible consistent with this disclosure.

FIG. 10 illustrates an exemplary computing device 1004 configured to implement aspects of the inventive decarbonization roadmap system described above, including those related to forecasting GHG emissions, generating MACCs, and executing decarbonization initiatives at an industrial facility. In one embodiment, computing device 1004 may represent at least a portion of decarbonization roadmap system 100 for generating, analyzing, and implementing comprehensive decarbonization roadmaps. For example, components described previously, such as the GHG emission data memory 106, the decarbonization roadmap data processor 108, and the emission reduction initiative output translator 110, may be implemented, at least in part, by computing device 1004. In some embodiments, the computing device 1004 integrates Modules 1, 2, and 3 functionalities, enabling real-time data processing and informed decision-making based on equipment-level GHG emissions data, facility operational parameters, and corporate-level emissions reduction targets.

As illustrated in FIG. 10, the computing device 1004 includes a processor 1006, input/output (I/O) hardware 1012, network interface hardware 1014, GHG emission data memory 1022, and a memory component 1018. These components cooperate to perform the decarbonization-related steps previously described. For instance, the GHG emission data memory 1022 may store emissions data and related operational parameters obtained from facility sensors, which may be processed by the decarbonization roadmap data processor 108 to forecast baseline emissions, identify candidate decarbonization initiatives, and prioritize those initiatives based on cost-effectiveness and feasibility.

The memory component 1018 may be configured as volatile and/or nonvolatile memory, including RAM, flash memory, optical disks, cloud-based storage, or other non-transitory computer-readable media. The memory component 1018 stores operating logic 1008 and instructions for the decarbonization roadmap data processor 108. When executed by processor 1006, these instructions implement specialized logic and functions discussed previously, such as developing BAU emissions forecasts, constructing MACCs, and establishing implementation timelines for selected decarbonization initiatives.

A local communications interface 1020 provides a communication pathway among the processor 1006, I/O hardware 1012, network interface hardware 1014, GHG emission data memory 1022, and memory component 1018. Through this interface 1020, the computing device 1004 can efficiently exchange data internally. In addition, the network interface hardware 1014 may enable communication with external databases, corporate planning tools, offset registries, or third-party power suppliers, thereby supporting a holistic decarbonization strategy aligned with previously described inventive aspects.

The processor 1006, executing instructions from the memory component 1018, may access data stored in the GHG emission data memory 1022 and utilize information from other system components or external sources. The I/O hardware 1012 may present users with dashboards or control panels for reviewing emissions forecasts, MACCs, and recommended initiatives, allowing facility managers to implement changes promptly. The network interface hardware 1014 facilitates real-time updates of emissions data and external conditions, ensuring that the decarbonization roadmap remains dynamic and responsive.

The operating logic 1008 may include system-level software to manage these components, while the decarbonization roadmap data processor 108 provides specialized computations and logic flows central to the inventive processes, such as evaluating technology readiness, cost metrics, and offsetting requirements.

While FIG. 10 depicts certain components within computing device 1004, it should be understood that one or more components may reside externally or be distributed across multiple devices. Likewise, logic such as operating logic 1008 and the decarbonization roadmap data processor 108 may be integrated or partitioned differently depending on implementation details without departing from the inventive aspects described herein.

While particular embodiments and aspects of the present disclosure have been illustrated and provided herein, various other changes and modifications can be made without departing from the spirit and scope of the disclosure. Moreover, although various aspects have been provided herein, such aspects need not be utilized in combination. Accordingly, it is therefore intended that the appended claims cover all such changes and modifications that are within the scope of the embodiments shown and provided herein.

Various aspects provide a system for generating and implementing real-time decarbonization roadmaps for at least one industrial facility. Specifically, a first aspect includes at least one industrial facility GHG monitoring system, including at least one sensor coupled to a first network, the at least one sensor configured to obtain GHG emissions data associated with equipment of the at least one industrial facility, the GHG emissions data including GHG emission metrics associated with two or more GHG emission types comprising at least one of combustion, venting, flaring, fugitives, and utility consumption; a decarbonization roadmap management system comprising: a GHG emission data memory, a decarbonization roadmap data processor, a memory component, and an emission reduction initiative output translator, wherein the GHG emission data memory is configured to store GHG emissions data received from the first network, and the memory component is configured to store decarbonization model data processing instructions that, when executed by the decarbonization roadmap data processor, cause the decarbonization roadmap management system to perform at least the following: forecast GHG emissions for the at least one industrial facility under a BAU scenario using the GHG emissions data, wherein the forecast is for a defined timeframe; categorize elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources; receive at least one decarbonization initiative, the at least one decarbonization initiative comprising at least one of an energy efficiency measure, a carbon capture and storage initiative, or a GHG emissions offsetting initiative; identify one or more of the decarbonization initiatives applicable to the at least two emissions scopes, wherein the identified one or more decarbonization initiatives are selected based on the GHG emissions sources identified in the emissions data; generate MACCs for the identified one or more decarbonization initiatives, wherein the MACCs include at least one GHG emission reduction metric, at least one associated financial metric, and at least one implementation metric, wherein the at least one associated financial metric includes at least one of a capital expenditure, operational expenditure, or lifecycle costs, and the at least one implementation metric is based on at least one of an implementation feasibility or an implementation timeframe; generate one or more implementation directives including at least one of an operational control parameter, schedule for execution of identified decarbonization initiative, or a decarbonization roadmap visualization; and communicate the one or more implementation directives to the GHG emission reduction initiative output translator; a controlled facility emissions system, configured to: receive from the GHG emission reduction initiative output translator, the one or more implementation directives; and implement the received one or more implementation directives by performing at least one of: adjusting emissions control devices of the at least one industrial facility, modifying an operating parameter of at least one renewable energy system of the at least one industrial facility, or modifying an operational parameter of equipment of the at least one industrial facility.

A second aspect includes the system of the first aspect, wherein the GHG emissions data obtained by the at least one industrial facility GHG monitoring system includes real-time data collected from one or more sensors measuring at least one of: fuel gas consumption of the facility, electricity usage of the facility, steam flow of the facility, hydrogen consumption of the facility, or production throughput of the facility.

A third aspect includes the system of the first aspect, wherein the one or more of the decarbonization initiatives comprise at least one of: solar energy deployment, wind energy deployment, or hydrogen fuel use.

A fourth aspect includes the system of the first aspect, wherein the decarbonization roadmap management system generates MACCs by integrating forecasted equipment-level throughput data to calculate an emission reduction potential for each decarbonization initiative, wherein the throughput data comprises at least one of: production rates of specific equipment within the facility, flow rates of materials through processing units, energy consumption rates of equipment, or operational capacity of emissions-related equipment.

A fifth aspect includes the system of the first aspect, wherein the GHG monitoring system includes at least one internet-of-things (IoT)-enabled sensor configured to transmit GHG emissions data to the first network, and wherein the transmitted GHG emissions data is processed by the decarbonization roadmap management system in real-time to generate updated implementation directives.

A sixth aspect includes the system of the first aspect, wherein the decarbonization roadmap data processor is configured to: analyze impacts of decarbonization initiatives based on a change in at least one of production capacity of one or more facilities or equipment availability at one or more facilities; and modify at least one MACC by recalculating GHG emissions abatement potential.

A seventh aspect includes the system of the first aspect, wherein the decarbonization roadmap data processor is configured to normalize the categorized GHG emissions data based on operational variations, including at least one of: planned maintenance shutdowns, unplanned outages, or throughput fluctuations.

An eighth aspect includes the system of the first aspect, wherein the decarbonization roadmap data processor cascades corporate-level emissions reduction targets into facility-level targets by: allocating target GHG emissions reductions to one or more facilities based on facility emission sources, facility operational capabilities, and historical emissions data of the facility; and selecting one or more decarbonization initiatives for each facility of the one or more facilities based on the allocated target reductions, wherein the selection of the one or more decarbonization initiatives is based on an evaluation of decarbonization initiative implementation cost, decarbonization initiative abatement potential, and feasibility of the one or more decarbonization initiative.

A ninth aspect includes the system of the first aspect, wherein the GHG emission data memory is configured to store real-time and historical data comprising at least one of: fuel gas consumption data, steam consumption data, electricity consumption data, direct process emissions data, or carbon intensity data for externally sourced energy.

A tenth aspect includes the system of the first aspect, wherein the decarbonization roadmap data processor is configured to prioritize a decarbonization initiative of the MACCs based on at least one of: a technology readiness level associated with a decarbonization initiative, an implementation feasibility metric associated with a decarbonization initiative, or a projected cost effectiveness associated with a decarbonization initiative.

An eleventh aspect includes the system of the first aspect, wherein the GHG emissions forecasts are generated based on emissions drivers, including at least one of: raw gas or oil composition of the facility, electricity demand of the facility, carbon intensity metric associated with externally sourced energy, and availability and utilization of GHG emissions control equipment.

A twelfth aspect includes the system of the first aspect, wherein the decarbonization roadmap management system is configured to generate separate MACCs for at least two distinct target years, wherein the MACCs are specific to facility-level emissions reductions for each target year.

A thirteenth aspect includes the system of the first aspect, wherein the decarbonization roadmap data processor includes a group prioritization engine configured to: receive decarbonization initiatives and associated emissions data from a plurality of facilities; evaluate the combined emissions reduction potential of the received decarbonization initiatives across the plurality of facilities; select one or more decarbonization initiatives for implementation across the plurality of facilities based on capital expenditure and emissions reduction potential; and generate a combined facility implementation timeline that specifies deployment schedules, resource allocation, and interdependencies for the selected one or more decarbonization initiatives across the plurality of facilities.

A fourteenth aspect includes the system of the first aspect, wherein the decarbonization roadmap data processor is further configured to: receive end product data comprising properties and quantities of products generated by the facility; forecast GHG emissions associated with downstream use of the facility's end products; incorporate the forecasted GHG emissions into emissions reduction targets; and integrate GHG emissions considerations into the generated MACCs and implementation directives.

A fifteenth aspect includes a method for generating and implementing real-time decarbonization roadmaps for at least one industrial facility, the method comprising: obtaining, by at least one sensor coupled to a first network, GHG emissions data associated with equipment of the at least one industrial facility, the GHG emissions data including GHG emission metrics associated with two or more GHG emission types comprising at least one of combustion, venting, flaring, fugitives, and utility consumption; storing, in a GHG emission data memory, the obtained GHG emissions data; executing, by a decarbonization roadmap data processor configured with a memory component storing decarbonization model data processing instructions, steps comprising: forecasting GHG emissions for the at least one industrial facility under a BAU scenario using the GHG emissions data, wherein the forecast is for a defined timeframe; categorizing elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources; receiving at least one decarbonization initiative, the at least one decarbonization initiative comprising at least one of an energy efficiency measure, a carbon capture and storage initiative, or a GHG emissions offsetting initiative; identifying one or more of the received decarbonization initiatives applicable to the at least two emissions scopes, wherein the identified one or more decarbonization initiatives are selected based on the GHG emissions sources identified in the emissions data; generating MACCs for the identified one or more decarbonization initiatives, wherein the MACCs include at least one GHG emission reduction metric, at least one associated financial metric including at least one of a capital expenditure, operational expenditure, or lifecycle costs, and at least one implementation metric based on at least one of implementation feasibility or an implementation timeframe; generating one or more implementation directives including at least one of an operational control parameter, a schedule for execution of the identified decarbonization initiative, or a decarbonization roadmap visualization; and communicating the one or more implementation directives to an emission reduction initiative output translator; and implementing, by a controlled facility emissions system in communication with the emission reduction initiative output translator, the one or more implementation directives by performing at least one of: adjusting emissions control devices of the at least one industrial facility, modifying an operating parameter of at least one renewable energy system of the at least one industrial facility, or modifying an operational parameter of equipment of the at least one industrial facility.

A sixteenth aspect includes a non-transitory computer-readable storage medium that that stores logic that, when executed by a computing device, causes the computing device to perform at least the following: obtaining, by at least one sensor coupled to a first network, GHG emissions data associated with equipment of the at least one industrial facility, the GHG emissions data including GHG emission metrics associated with two or more GHG emission types comprising at least one of combustion, venting, flaring, fugitives, and utility consumption; storing, in a GHG emission data memory, the obtained GHG emissions data; executing, by a decarbonization roadmap data processor configured with a memory component storing decarbonization model data processing instructions, steps comprising: forecasting GHG emissions for the at least one industrial facility under a BAU scenario using the GHG emissions data, wherein the forecast is for a defined timeframe; categorizing elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources; receiving at least one decarbonization initiative, the at least one decarbonization initiative comprising at least one of an energy efficiency measure, a carbon capture and storage initiative, or a GHG emissions offsetting initiative; identifying one or more of the received decarbonization initiatives applicable to the at least two emissions scopes, wherein the identified one or more decarbonization initiatives are selected based on the GHG emissions sources identified in the emissions data; generating marginal abatement cost curves (MACCs) for the identified one or more decarbonization initiatives, wherein the MACCs include at least one GHG emission reduction metric, at least one associated financial metric including at least one of a capital expenditure, operational expenditure, or lifecycle costs, and at least one implementation metric based on at least one of implementation feasibility or an implementation timeframe; generating one or more implementation directives including at least one of an operational control parameter, a schedule for execution of the identified decarbonization initiative, or a decarbonization roadmap visualization; and communicating the one or more implementation directives to an emission reduction initiative output translator; and implementing, by a controlled facility emissions system in communication with the emission reduction initiative output translator, the one or more implementation directives by performing at least one of: adjusting emissions control devices of the at least one industrial facility, modifying an operating parameter of at least one renewable energy system of the at least one industrial facility, or modifying an operational parameter of equipment of the at least one industrial facility.

It should now be understood that embodiments disclosed herein include systems, methods, and non-transitory computer-readable mediums for providing controllable hydrocarbon parameters to at least one of a controllable hydrocarbon infrastructure asset or a controllable hydrocarbon operational asset. It should also be understood that these embodiments are merely exemplary and are not intended to limit the scope of this disclosure.

What is claimed is:

1. A system for implementing real-time decarbonization for at least one industrial facility, comprising:
at least one industrial facility greenhouse gas (GHG) monitoring system, including at least one sensor coupled to a first network, the at least one sensor configured to obtain GHG emissions data associated with equipment of the at least one industrial facility, the GHG emissions data including GHG emission metrics associated with two or more GHG emission types comprising at least one of combustion, venting, flaring, fugitives, and utility consumption;
a decarbonization roadmap management system comprising:
a GHG emission data memory,
a decarbonization roadmap data processor,
a memory component, and
a GHG emission reduction initiative output translator,
wherein the GHG emission data memory is configured to store GHG emissions data received from the first network, and the memory component is configured to store decarbonization model data processing instructions that, when executed by the decarbonization roadmap data processor, cause the decarbonization roadmap management system to perform at least the following:
forecast GHG emissions for the at least one industrial facility under a business-as-usual (BAU) scenario using the GHG emissions data, wherein the forecast is for a defined timeframe;
categorize elements of the GHG emissions data into at least two emissions scopes, wherein a first scope comprises direct emissions associated with equipment of the at least one industrial facility, and a second scope comprises indirect emissions based on energy consumption of the at least one industrial facility provided from external sources;
receive at least one decarbonization initiative, the at least one decarbonization initiative comprising at least one of an energy efficiency measure, a carbon capture and storage initiative, or a GHG emissions offsetting initiative;
identify one or more of the decarbonization initiatives applicable to the at least two emissions scopes, wherein the identified one or more of the decarbonization initiatives are selected based on the GHG emissions types identified in the GHG emissions data;
generate marginal abatement cost curves (MACCs) for the identified one or more of the decarbonization initiatives, wherein the MACCs include at least one GHG emission reduction metric, at least one associated financial metric, and at least one implementation metric, wherein the at least one associated financial metric includes at least one of a capital expenditure, operational expenditure, or lifecycle costs, and the at least one implementation metric is based on at least one of an implementation feasibility or an implementation timeframe;
generate one or more implementation directives including at least one of an operational control parameter, schedule for execution of identified decarbonization initiative, or a decarbonization roadmap visualization; and
communicate the one or more implementation directives to the GHG emission reduction initiative output translator;
a controlled facility emissions system, configured to:
receive from GHG emission reduction initiative output translator, the one or more implementation directives; and
implement the received one or more implementation directives by performing at least one of:
adjusting emissions control devices of the at least one industrial facility,
modifying an operating parameter of at least one renewable energy system of the at least one industrial facility, or
modifying an operational parameter of equipment of the at least one industrial facility.

2. The system of claim 1, wherein the GHG emissions data obtained by the at least one industrial facility GHG monitoring system includes real-time data collected from one or more sensors measuring at least one of: fuel gas consumption of the facility, electricity usage of the facility, steam flow of the facility, hydrogen consumption of the facility, or production throughput of the facility.

3. The system of claim 1, wherein the one or more of the decarbonization initiatives comprise at least one of: solar energy deployment, wind energy deployment, or hydrogen fuel use.

4. The system of claim 1, wherein the decarbonization roadmap management system generates MACCs by integrating forecasted equipment-level throughput data to calculate an emission reduction potential for each decarbonization initiative, wherein the forecasted equipment-level throughput data comprises at least one of:
production rates of specific equipment within the at least one industrial facility,
flow rates of materials through processing units,
energy consumption rates of equipment, or
operational capacity of emissions-related equipment.

5. The system of claim 1, wherein the GHG monitoring system includes at least one internet-of-things (IoT)-enabled sensor configured to transmit GHG emissions data to the first network, and wherein the transmitted GHG emissions data is processed by the decarbonization roadmap management system in real-time to generate updated implementation directives.

6. The system of claim 1, wherein the decarbonization roadmap data processor is configured to:
analyze impacts of decarbonization initiatives based on a change in at least one of production capacity of one or more facilities or equipment availability at one or more facilities; and
modify at least one MACC by recalculating GHG emissions abatement potential.

7. The system of claim 1, wherein the decarbonization roadmap data processor is configured to normalize the categorized GHG emissions data based on operational variations, including at least one of: planned maintenance shutdowns, unplanned outages, or throughput fluctuations.

8. The system of claim 1, wherein the decarbonization roadmap data processor cascades corporate-level emissions reduction targets into facility-level targets by:
allocating target GHG emissions reductions to one or more facilities based on facility emission sources, facility operational capabilities, and historical emissions data of the facility; and
selecting one or more decarbonization initiatives for each facility of the one or more facilities based on the allocated target GHG emissions reductions, wherein the selection of the one or more decarbonization initiatives is based on an evaluation of decarbonization initiative implementation cost, decarbonization initiative abatement potential, and feasibility of the one or more decarbonization initiative.

9. The system of claim 1, wherein the GHG emission data memory is configured to store real-time and historical data comprising at least one of:
fuel gas consumption data,
steam consumption data,
electricity consumption data,
direct process emissions data, or
carbon intensity data for externally sourced energy.

10. The system of claim 1, wherein the decarbonization roadmap data processor is configured to prioritize a decarbonization initiative of the MACCs based on at least one of: a technology readiness level associated with a decarbonization initiative, an implementation feasibility metric associated with a decarbonization initiative, or a projected cost effectiveness associated with a decarbonization initiative.

11. The system of claim 1, wherein the GHG emissions forecasts are generated based on emissions drivers, including at least one of:
raw gas or oil composition of the at least one industrial facility,
electricity demand of the at least one industrial facility,
carbon intensity metric associated with externally sourced energy, and
availability and utilization of GHG emissions control equipment.

12. The system of claim 1, wherein the decarbonization roadmap management system is configured to generate separate marginal abatement cost curves (MACCs) for at least two distinct target years, wherein the MACCs are specific to facility-level emissions reductions for each target year.

13. The system of claim 1, wherein the decarbonization roadmap data processor includes a group prioritization engine configured to:
receive decarbonization initiatives and associated emissions data from a plurality of facilities;
evaluate a combined emissions reduction potential of the received decarbonization initiatives across the plurality of facilities;
select one or more decarbonization initiatives for implementation across the plurality of facilities based on capital expenditure and emissions reduction potential; and
generate a combined facility implementation timeline that specifies deployment schedules, resource allocation, and interdependencies for the identified one or more of the decarbonization initiatives across the plurality of facilities.

14. The system of claim 1, wherein the decarbonization roadmap data processor is further configured to:
receive end product data comprising properties and quantities of products generated by the at least one industrial facility;
forecast GHG emissions associated with downstream use of end products associated with the at least one industrial facility;
incorporate the forecasted GHG emissions into emissions reduction targets; and
integrate GHG emissions considerations into the generated MACCs and implementation directives.

15. A method for generating and implementing decarbonization strategies for at least one industrial operation, the method comprising:
obtaining emissions-related data associated with equipment of the at least one industrial operation;
forecasting greenhouse gas (GHG) emissions for a defined timeframe based at least in part on the obtained emissions-related data;
categorizing emissions sources based on the obtained emissions-related data to form at least one emissions grouping;
receiving one or more decarbonization initiatives, each decarbonization initiative of the one or more decarbonization initiatives associated with mitigating GHG emissions;
identifying at least one decarbonization initiative from the received one or more decarbonization initiatives that is applicable to the categorized emissions sources;
generating metrics indicative of cost-effectiveness and feasibility for the identified at least one decarbonization initiative, wherein the metrics reflect predicted emission reductions, financial factors, and implementation parameters;
producing directives for implementing the identified at least one decarbonization initiative; and
implementing the produced directives by adjusting at least one operational parameter related to equipment or energy use in the at least one industrial operation.

16. The method of claim 15, wherein obtaining the emissions-related data includes collecting real-time data from one or more sensors measuring at least one of: fuel gas consumption of the at least one industrial operation, electricity usage of the at least one industrial operation, steam flow of the at least one industrial operation, hydrogen consumption of the at least one industrial operation, or production throughput of the at least one industrial operation.

17. The method of claim 15, wherein the at least one decarbonization initiative comprises at least one of: solar energy deployment, wind energy deployment, or hydrogen fuel use.

18. The method of claim 15, wherein generating metrics indicative of cost-effectiveness and feasibility includes integrating forecasted equipment-level throughput data to calculate emission reduction potential for the at least one decarbonization initiative, the throughput data comprising at least one of: production rates of specific equipment, flow rates of materials through processing units, energy consumption rates of equipment, or operational capacity of emissions-related equipment.

19. The method of claim 15, further comprising:
receiving emissions-related data in real-time from at least one internet-of-things (IoT)-enabled sensor; and
dynamically updating the produced directives based on the received emissions-related data.

20. A non-transitory computer-readable storage medium that that stores logic that, when executed by a computing device, causes the computing device to perform at least the following:
obtain emissions-related data associated with equipment of at least one industrial operation;
forecast greenhouse gas (GHG) emissions for a defined timeframe based at least in part on the obtained emissions-related data;
categorize emissions sources based on the obtained emissions-related data to form at least one emissions grouping;
receive one or more decarbonization initiatives, each decarbonization initiative of the one or more decarbonization initiatives associated with mitigating GHG emissions;
identify at least one decarbonization initiative from the received one or more decarbonization initiatives that is applicable to the categorized emissions sources;
generate metrics indicative of cost-effectiveness and feasibility for the identified at least one decarbonization initiative, wherein the metrics reflect predicted emission reductions, financial factors, and implementation parameters;
produce directives for implementing the identified at least one decarbonization initiative; and
implement the produced directives by adjusting at least one operational parameter related to equipment or energy use in the at least one industrial operation.
